(19) United States
(12) Patent Application Publication
(10) Pub. No.: US 2024/0194884 A1
(43) Pub. Date: Jun. 13, 2024

(54) All-Solid-State Battery Operable at Room Temperature and Low Pressure and Method of Manufacturing the Same

(71) Applicants: Hyundai Motor Company, Seoul (KR); Kia Corporation, Seoul (KR); Seoul National University R&DB Foundation, Seoul (KR)

(72) Inventors: Ga Hyeon Im, Hwaseong-si (KR); Yun Sung Kim, Hwaseong-si (KR); Sang Heon Lee, Yongin-si (KR); Hong Seok Min, Yongin-si (KR); Jang Wook Choi, Seoul (KR); Ji Hoon Oh, Seoul (KR); Noh Joon Lee, Seoul (KR); Ye Eun Sohn, Seoul (KR)

(21) Appl. No.: 18/355,158

(22) Filed: Jul. 19, 2023

(30) Foreign Application Priority Data
Dec. 2, 2022 (KR) 10-2022-0166611

(51) Int. Cl. H01M 4/62; H01M 4/04

(52) U.S. Cl. CPC H01M 4/625; H01M 4/0416; H01M 4/623; H01M 4/626

(57) ABSTRACT

An embodiment all-solid-state battery includes an anode current collector, a buffer layer disposed on the anode current collector, a solid electrolyte layer disposed on the buffer layer and including a solid electrolyte, a cathode active material layer disposed on the solid electrolyte layer, and a cathode current collector disposed on the cathode active material layer. The buffer layer includes a first layer disposed on the anode current collector and including an electrically conductive material, and a second layer disposed on the first layer and including a metal capable of alloying with lithium.

### CROSS-REFERENCE TO RELATED APPLICATIONS

This application claims the benefit of Korean Patent Application No. 10-2022-0166611, filed on Dec. 2, 2022, which application is hereby incorporated herein by reference.

### TECHNICAL FIELD

The present disclosure relates to an all-solid-state battery operable at room temperature and low pressure and a method of manufacturing the same.

### BACKGROUND

An all-solid-state battery includes a cathode active material layer attached to a cathode current collector, an anode active material layer attached to an anode current collector, and a solid electrolyte layer interposed between the cathode active material layer and the anode active material layer.

The anode active material layer includes an anode active material, such as graphite or silicon, and a solid electrolyte. The solid electrolyte conducts lithium ions (Li⁺) in the anode active material layer. However, since the solid electrolyte has a greater specific gravity than a liquid electrolyte, the energy density of the all-solid-state battery is lower than that of a lithium ion battery.

In order to increase the energy density of the all-solid-state battery, a storage-type anodeless all-solid-state battery, in which an anode active material layer is excluded and lithium ions (Li⁺) are directly deposited in the form of lithium metal or a lithium alloy on an anode current collector, has been proposed.

The anodeless all-solid-state battery does not use an anode active material, which may store lithium ions. In charging the battery, lithium ions (Li⁺) disintercalated from a cathode active material layer pass through a solid electrolyte layer, cause a reduction reaction with electrons on the surface of the anode current collector, and are thus converted into lithium metal. In discharging the battery, a counter electrochemical reaction occurs. That is, the anodeless all-solid-state battery may be charged and discharged without the anode active material.

In order to achieve reversible charging and discharging of the anodeless all-solid-state battery, the lithium metal should be uniformly deposited on the surface of the anode current collector and growth of dendrites should be suppressed in charging the battery.

However, pores are formed between the solid electrolyte layer and the anode current collector due to the irregular surface of the solid electrolyte layer and the hardness of the anode current collector, and thus, it is difficult to uniformly deposit lithium metal. Therefore, in order to operate the anodeless all-solid-state battery, a high temperature and/or a high pressure should be applied to the anodeless all-solid-state battery.

The above information disclosed in this background section is only for enhancement of understanding of the background of embodiments of the invention and therefore it may contain information that does not form the prior art that is already known to a person of ordinary skill in the art.

### SUMMARY

Embodiments of the present disclosure can solve problems associated with the prior art, and an embodiment of the present disclosure provides an all-solid-state battery operable at room temperature and low pressure and a method of manufacturing the same.

A term “all-solid-state battery” as used herein refers to a rechargeable secondary battery that includes an electrolyte in a solid state. In certain embodiments, the all-solid state battery may be an anodeless all-solid-state battery.

A term “anode-free all-solid-state battery,” “anodeless all-solid-state battery,” “anode-free battery,” or “anodeless battery” as used herein refers to an all-solid-state battery including a bare current collector at its anode side, which is in contrast to a battery that uses lithium metal as an anode. The anodeless all-solid-state battery may include a coating layer on the bare current collector containing materials that induce conduction of lithium ions to a surface of the bare current collector.

One embodiment of the present disclosure provides an all-solid-state battery including an anode current collector, a buffer layer disposed on the anode current collector, a solid electrolyte layer disposed on the buffer layer and including a solid electrolyte, a cathode active material layer disposed on the solid electrolyte layer, and a cathode current collector disposed on the cathode active material layer, wherein the buffer layer includes a first layer disposed on the anode current collector and including an electrically conductive material and a second layer disposed on the first layer and including a metal capable of alloying with lithium.

In a preferred embodiment, the electrical conductivity of the first layer may be 0.1 S/m to 10 S/m.

In another preferred embodiment, the electrically conductive material may include a MXene and a carbon material.

In still another preferred embodiment, the carbon material may include at least one selected from the group consisting of graphene, graphene oxide, reduced graphene oxide, and combinations thereof.

In yet another preferred embodiment, the first layer may include the MXene and the carbon material in a mass ratio of 10:90 to 90:10.

In still yet another preferred embodiment, the first layer may further include a binder, and the binder may include at least one selected from the group consisting of styrene butadiene rubber, carboxymethyl cellulose, polyvinylidene fluoride, and combinations thereof.

In a further preferred embodiment, the metal may include at least one selected from the group consisting of magnesium (Mg), silver (Ag), zinc (Zn), gold (Au), and combinations thereof.

In another further preferred embodiment, the thickness of the second layer may be 100 nm to 1,000 nm.

In still another further preferred embodiment, the thickness of the buffer layer may be 1 μm to 50 μm.

In yet another further preferred embodiment, the indentation depth of the buffer layer may be 100 nm to 300 nm based on an indentation load of 0.07 mN.

In still yet another further preferred embodiment, the restoration ratio of the buffer layer calculated by Equation 1 is 50% to 99%.

$$Restoration Ratio [ \% ] = \frac{Restoration Depth}{Indentation Depth} \times 100 \qquad Equation 1$$

In a still further preferred embodiment, when the all-solid-state battery is charged at a current density of 1 mA·cm⁻² under conditions of a temperature of 15° C. to 25° C. and a pressure of 1 MPa to 10 MPa, overvoltage may not occur or overvoltage equal to or less than 50 mV may occur.

Another embodiment of the present disclosure provides a method of manufacturing an all-solid-state battery including forming a first layer by applying a solution including an electrically conductive material to a substrate, forming a second layer by depositing a metal capable of alloying with lithium on the first layer, and manufacturing a stack including an anode current collector, a buffer layer disposed on the anode current collector and including the first layer and the second layer, a solid electrolyte layer disposed on the buffer layer and including a solid electrolyte, a cathode active material layer disposed on the solid electrolyte layer, and a cathode current collector disposed on the cathode active material layer.

In a preferred embodiment, the solution may include the electrically conductive material, a binder, and a solvent.

In another preferred embodiment, the solvent may include at least one selected from the group consisting of N-methyl-2-pyrrolidone, water, ethanol, isopropanol, and combinations thereof.

Other aspects and preferred embodiments of the invention are discussed infra.

The above and other features of embodiments of the invention are discussed infra.

### BRIEF DESCRIPTION OF THE DRAWINGS

The above and other features of embodiments of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows an all-solid-state battery according to embodiments of the present disclosure;

FIG. 2 shows charged state of the all-solid-state battery according to embodiments of the present disclosure;

FIG. 3 shows the surface of a buffer layer according to a Preparation Example, acquired by scanning electron microscopy (SEM) analysis;

FIG. 4 shows the surface of the buffer layer, acquired by SEM analysis at a different scale from FIG. 3;

FIG. 5 shows the surface of the buffer layer according to the Preparation Example, acquired by energy dispersive X-ray spectroscopy (EDS) analysis;

FIG. 6 shows an indentation load for the buffer layer according to the Preparation Example and a buffer layer according to a Comparative Preparation Example;

FIG. 7 shows initial charge and discharge voltages of half-cells according to Example 1 and Comparative Example 1;

FIG. 8 shows an enlarged graph of one capacity section of FIG. 7;

FIG. 9 shows results of charging and discharging a full cell according to Example 2 at room temperature and low pressure;

FIG. 10 shows results of charging and discharging a full cell according to Comparative Example 2 at room temperature and low pressure; and

FIG. 11 shows results of charging and discharging a full cell according to Comparative Example 3 at room temperature and low pressure.

It should be understood that the appended drawings are not necessarily to scale, presenting a somewhat simplified representation of various preferred features illustrative of the basic principles of embodiments of the invention. The specific design features of embodiments of the present disclosure as disclosed herein, including, for example, specific dimensions, orientations, locations, and shapes, will be determined in part by the particular intended application and use environment.

In the figures, reference numbers refer to the same or equivalent parts of embodiments of the present disclosure throughout the several figures of the drawings.

### DETAILED DESCRIPTION OF ILLUSTRATIVE EMBODIMENTS

The above-described objects, other objects, advantages, and features of embodiments of the present disclosure will become apparent from the descriptions of exemplary embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the following description of the embodiments, the same elements are denoted by the same reference numerals even when they are depicted in different drawings. In the drawings, the dimensions of structures may be exaggerated compared to the actual dimensions thereof for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the invention. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements, or parts stated in the description or combinations thereof, and do not exclude the presence of one or more other characteristics, numbers, steps, operations, elements, parts, or combinations thereof, or the possibility of adding the same. In addition, it will be understood that, when a part, such as a layer, a film, a region, or a plate, is said to be “on” another part, the part may be located “directly on” the other part or other parts may be interposed between the two parts. In the same manner, it will be understood that, when a part, such as a layer, a film, a region, or a plate, is said to be “under” another part, the part may be located “directly under” the other part or other parts may be interposed between the two parts.

All numbers, values, and/or expressions representing amounts of components, reaction conditions, polymer compositions, and blends used in the description are approximations in which various uncertainties in measurement generated when these values are acquired from essentially different things are reflected and thus it will be understood that they are modified by the term “about,” unless stated otherwise. In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

An all-solid-state battery according to embodiments of the present disclosure may be an anodeless all-solid-state battery which does not include an anode active material. In order to reversibly charge and discharge the anodeless all-solid-state battery at room temperature and/or low pressure, an interface between a solid electrolyte layer and another element and an interface between an anode current collector and another element should be stable. Embodiments of the present disclosure relate to the all-solid-state battery which may be operated at room temperature and/or low pressure by inserting a buffer layer having good ductility between the solid electrolyte layer and the anode current collector.

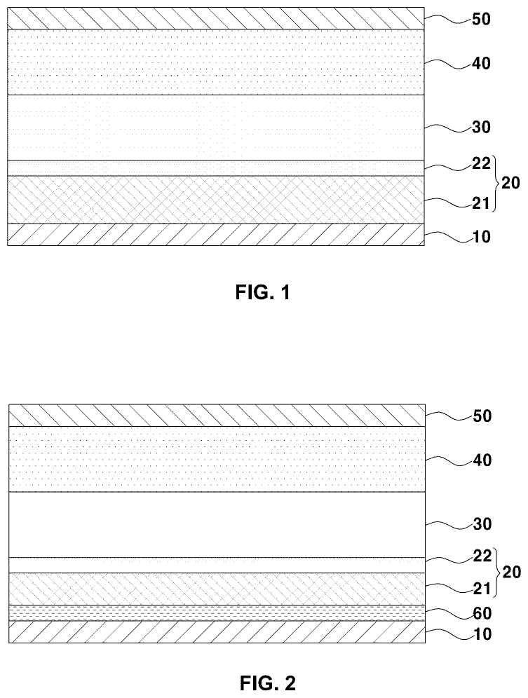

FIG. 1 shows the all-solid-state battery according to embodiments of the present disclosure. The all-solid-state battery may include an anode current collector 10, a buffer layer 20 disposed on the anode current collector 10, a solid electrolyte layer 30 disposed on the buffer layer 20, a cathode active material layer 40 disposed on the solid electrolyte layer 30, and a cathode current collector 50 disposed on the cathode active material layer 40.

The anode current collector 10 may be a plate-shaped substrate having electrical conductivity. Concretely, the anode current collector 10 may be formed in the form of a sheet, thin film, or foil.

The anode current collector 10 may include a material which does not react with lithium. Concretely, the anode current collector 10 may include at least one selected from the group consisting of nickel (Ni), copper (Cu), stainless steel, and combinations thereof.

The thickness of the anode current collector 10 is not limited to a specific value, and may be, for example, 1 μm to 500 μm.

The buffer layer 20 may include a first layer 21 disposed on the anode current collector 10 and including an electrically conductive material and a second layer 22 disposed on the first layer 21 and including a metal which may form an alloy with lithium.

FIG. 2 shows a charged state of the all-solid-state battery according to embodiments of the present disclosure. The all-solid-state battery in the charged state may further include a deposited layer 60 including lithium between the anode current collector 10 and the buffer layer 20. Lithium ions disintercalated from the cathode active material layer 40 at the beginning of charging the all-solid-state battery migrate to the buffer layer 20 through the solid electrolyte layer 30. The lithium ions are induced by the first layer 21 and the second layer 22 and are reduced between the anode current collector 10 and the buffer layer 20 so as to produce the deposited layer 60.

The first layer 21 has high ductility and excellent electrical conductivity. The first layer 21 has high ductility and may thus maintain a uniform interface with the anode current collector 10 in the discharged state of the all-solid-state battery. Further, the first layer 21 has elasticity caused by high ductility and may thus minimize volume change due to formation of the deposited layer 60.

The first layer 21 may contribute to formation of a uniform interface between the second layer 22 and the solid electrolyte layer 30. When the second layer 22 is directly coated on the anode current collector 10, ductility of the second layer 22 is inhibited by hardness of the anode current collector 10. Therefore, pores are formed in the interface between the second layer 22 and the solid electrolyte layer 30. When contact between the second layer 22 and the solid electrolyte layer 30 is poor, current is concentrated on a local area in which both elements come into contact with each other, and thus, lithium dendrites are formed. In embodiments of the present disclosure, the second layer 22 is formed on the first layer 21 having high ductility and is thus ductile so as to form a uniform interface between the second layer 22 and the solid electrolyte layer 30.

The first layer 21 may include an electrically conductive material, a binder, etc. The electrically conductive material may include a MXene and a carbon material.

The MXene is a ceramic material having a layer structure and may be represented by Formula 1 below.

Mₙ₊₁XₙTₛ Formula 1

Here, each X atom may be located in an octahedral array formed by M atoms.

M may include one selected from the group consisting of group IIIB metals, group IVB metals, group VB metals, group VIB metals, and combinations thereof.

X may include carbon (C) or nitrogen (N).

n may be 1, 2, or 3.

Tₛ may include a functional group of one selected from the group consisting of alkoxides, carboxylates, halides, hydroxides, hydrides, oxides, sub-oxides, nitrides, sub-nitrides, sulfides, thiols, and combinations thereof. MXenes are disclosed in U.S. Pat. No. 9,193,595 and International Patent Application No. PCT/US2015/051588 filed on Sep. 23, 2015 and, in order to instruct the compositions, (electrical) characteristics and manufacturing methods of MXenes, these Patent Documents are referred to. That is, arbitrary compositions of MXenes disclosed in the Patent Documents are considered as being applicable to embodiments of the present disclosure within the spirit and scope of the present disclosure.

Concretely, M may include at least one selected from the group consisting of Sc, Y, Lu, Ti, Zr, Hf, V, Nb, Ta, Cr, Mo, W, and combinations. Further, Mn+Xn may include at least one selected from the group consisting of Sc₂C, Ti₂C, V₂C, Cr₂C, Cr₂N, Zr₂C, Nb₂C, Hf₂C, Ti₃C₂, V₃C₂, Ta₃C₂, Ti₄C₃, V₄C₃, Ta₄C₃, combinations thereof, and mixtures thereof. In a specific example of implementation, Mₙ₊₁Xₙ may include Ti₃C₂, Ti₂C, Ta₄C₃, or (V_{1/2}Cr_{1/2})₃C₃.

The MXene having the Mₙ₊₁XₙTₛ composition may be in the state in which the surface of a kind of layer formed by the MXene is modified by Tₛ. Tₛ is a functional group combined with the surface of the layer and may indicate a hydrophilic functional group generated on the surface of the layer during a selective etching process.

Since the MXene has excellent electrical conductivity and high ductility, the first layer 21 including the MXene may contribute to minimization of volume change due to formation of the deposited layer 60, formation of a uniform interface between the buffer layer 20 and the anode current collector 10, and formation of a uniform interface between the buffer layer 20 and the solid electrolyte layer 30.

The carbon material is formed in a plate shape and may include at least one selected from the group consisting of graphene, graphene oxide, reduced graphene oxide, and combinations thereof. Here, the term “plate shape” does not indicate the shape of a plate from a macroscopic point of view but indicates a structure in which carbon atoms are collected to form a two-dimensional surface from a microscopic point of view.

The carbon material has a layer structure and excellent electrical conductivity similar to the MXene and may also implement the above-described effects.

The first layer 21 may include the MXene and the carbon material in a mass ratio of 10:90 to 90:10.

The binder may include at least one selected from the group consisting of styrene butadiene rubber, carboxymethyl cellulose, polyvinylidene fluoride, and combinations thereof.

The content of the binder is not limited to a specific value. For example, the first layer 21 may include 0.1 parts by weight to 10 parts by weight with respect to 100 parts by weight of a mixture of the MXene and the carbon material. The content of the binder may be appropriately adjusted depending on the thickness, area, etc. of the buffer layer 20.

The electrical conductivity of the first layer 21 may be 0.1 S/m to 10 S/m. The electrical conductivity may be understood as a value that quantifies how easily electrical charges move through a given material when subjected to an applied electric field. The electrical conductivity may indicate a value measured at room temperature by a conductivity meter.

The second layer 22 may allow lithium ions (Li⁺) having passed through the solid electrolyte layer 30 to more smoothly migrate to the anode current collector 10 in charging the all-solid-state battery.

The second layer 22 may include a metal which may form an alloy with lithium. The metal may include at least one selected from the group consisting of magnesium (Mg), silver (Ag), zinc (Zn), gold (Au), and combinations thereof.

The thickness of the second layer 22 may be 100 nm to 1,000 nm. When the thickness of the second layer 22 is less than 100 nm, pores may be formed between the second layer 22 and the solid electrolyte layer 30. When the thickness of the second layer 22 exceeds 1,000 nm, the irreversible capacity of the all-solid-state battery may be increased.

The thickness of the buffer layer 20 may be 1 μm to 50 μm. When the thickness of the buffer layer 20 is less than 1 μm, the interface between the buffer layer 20 and the anode current collector 10 and/or the interface between the buffer layer 20 and the solid electrolyte layer 30 may not be uniform. When the thickness of the buffer layer 20 exceeds 50 μm, the energy density of the all-solid-state battery may be reduced.

The indentation depth of the buffer layer 20 may be 100 nm to 300 nm based on an indentation load of 0.07 mN. Further, the restoration ratio of the buffer layer 20 calculated by Equation 1 below using the indentation depth may be 50% to 99%.

$$Restoration Ratio [ \% ] = \frac{Restoration Depth}{Indentation Depth} \times 100 \qquad Equation 1$$

The indentation depth may be measured using a nanoindenter. The indentation depth may be a value that quantifies how much the thickness of the buffer layer 20 is reduced by pressure applied by a tip of the nanoindenter when the tip is indented into the surface of the buffer layer 20. The surface of the buffer layer 20 into which the tip of the nanoindenter is indented may be the surface of the second layer 22. The tip of the nanoindenter may be provided in a Berkovich type or a conical type. The indentation depth may be a value measured when the maximum indentation load is set to 0.07 mN and a time taken to apply the indentation load is set to 15 seconds. As ductility of the buffer layer 20 increases, the indentation depth may increase.

Further, the restoration depth may be a value that quantifies how much the thickness of the buffer layer 20 is restored while reducing the load applied to the buffer layer 20 after indentation of the tip into the buffer layer 20 has been terminated. The restoration depth may be a value measured when a time taken to remove the indentation load is set to 15 seconds. The restoration ratio indicates a ratio of the restoration depth to the indentation depth, and it may be interpreted that, as the restoration ratio increases, elasticity of the buffer layer 20 increases.

When the indentation depth and the restoration ratio of the buffer layer 20 are within the above-described value ranges, volume change of the all-solid-state battery depending on formation of the deposited layer 60 may be minimized.

The solid electrolyte layer 30 is interposed between the cathode active material layer 40 and the buffer layer 20, and may include a solid electrolyte having lithium ion conductivity.

The solid electrolyte may include an oxide-based solid electrolyte, a sulfide-based solid electrolyte, or the like. Particularly, a sulfide-based solid electrolyte having high lithium ion conductivity may be used. The sulfide-based solid electrolyte may include Li₂S—P₂S₅, Li₂S—P₂S₅-LiI, Li₂S—P₂S₅-LiCl, Li₂S—P₂S₅-LiBr, Li₂S—P₂S₅-Li₂O, Li₂S—P₂S₅-Li₂O—LiI, Li₂S—SiS₂, Li₂S—SiS₂-LiI, Li₂S—SiS₂-LiBr, Li₂S—SiS₂-LiCl, Li₂S—SiS₂-B₂S₃-LiI, Li₂S—SiS₂-P₂S₅-LiI, Li₂S—B₂S₃, Li₂S—P₂S₅—ZₘSₙ (m and n being positive numbers, and Z being one of Ge, Zn, and Ga), Li₂S—GeS₂, Li₂S—SiS₂-Li₃PO₄, Li₂S—SiS₂-LiₓMO_{y} (x and y being positive numbers, and M being one of P, Si, Ge, B, Al, Ga, and In), or Li₁₀GeP₂S₁₂, without being limited thereto.

The oxide-based solid electrolyte may include perovskite-type LLTO (L₃ₓLa_{2/3-x}TiO₃) or phosphate-based NASICON-type LATP (Li₁₊ₓAlₓTi₂₋ₓ(PO₄)₃).

The cathode active material layer 40 may include a cathode active material, a solid electrolyte, a conductive material, a binder, etc.

The cathode active material may intercalate and disintercalate lithium ions.

The cathode active material may include a rock salt layer-type active material, such as LiCoO₂, LiMnO₂, LiNiO₂, LiVO₂ or Li₁₊ₓNi_{1/3}Co_{1/3}Mn_{1/3}O, a spinel-type active material, such as LiMn₂O₄ or Li(Ni_{0.5}Mn_{1.5})O₄, an inverted spinel-type active material, such as LiNiVO₄ or LiCoVO₄, an olivine-type active material, such as LiFePO₄, LiMnPO₄, LiCoPO₄ or LiNiPO₄, a silicon-containing active material, such as Li₂FeSiO₄ or Li₂MnSiO₄, a rock salt layer-type active material in which a part of a transition metal is substituted with a different kind of metal, such as LiNi_{0.8} Co_{(0.2-x)}AlₓO₂ (0<x<0.2), a spinel-type active material in which a part of a transition metal is substituted with a different kind of metal, such as Li₁₊ₓMn_{2-x-y}M_{y}O₄ (M being at least one of Al, Mg, Co, Fe, Ni or Zn, and 0<x+y<₂), or lithium titanate, such as Li₄Ti₅O₁₂.

The solid electrolyte may include an oxide-based solid electrolyte or a sulfide-based solid electrolyte. Particularly, a sulfide-based solid electrolyte having high lithium ion conductivity may be used. The sulfide-based solid electrolyte may be Li₂S—P₂S₅, Li₂S—P₂S₅-LiI, Li₂S—P₂S₅-LiCl, Li₂S—P₂S₅-LiBr, Li₂S—P₂S₅-Li₂O, Li₂S—P₂S₅-Li₂O—LiI, Li₂S—SiS₂, Li₂S—SiS₂-LiI, Li₂S—SiS₂-LiBr, Li₂S—SiS₂-LiCl, Li₂S—SiS₂-B₂S₃-LiI, Li₂S—SiS₂-P₂S₅-LiI, Li₂S—B₂S₃, Li₂S—P₂S₅-ZₘSₙ (m and n being positive numbers, and Z being one of Ge, Zn, and Ga), Li₂S—GeS₂, Li₂S—SiS₂-Li₃PO₄, Li₂S—SiS₂-LiₓMO_{y} (x and y being positive numbers, and M being one of P, Si, Ge, B, Al, Ga, and In), or Li₁₀GeP₂S₁₂, without being limited to a specific material. The solid electrolyte included in the cathode active material layer 40 may be the same as or different from the solid electrolyte included in the solid electrolyte layer 30.

The conductive material may include carbon black, conductive graphite, ethylene black, graphene, or the like.

The binder may include butadiene rubber (BR), nitrile butadiene rubber (NBR), hydrogenated nitrile butadiene rubber (HNBR), polyvinylidene fluoride (PVDF), polytetrafluoroethylene (PTFE), carboxymethyl cellulose (CMC), or the like.

The cathode current collector 50 may be a plate-shaped substrate having electrical conductivity. The cathode current collector 50 may include aluminum foil.

The thickness of the cathode current collector 50 is not limited to a specific value and may be, for example, 1 μm to 500 μm.

A method of manufacturing the all-solid-state battery according to embodiments of the present disclosure may include forming the first layer 21 by applying a solution including an electrically conductive material to a substrate, forming the second layer 22 by depositing a metal, which may form an alloy with lithium, on the first layer 21, and manufacturing a stack by sequentially stacking the anode current collector 10, the buffer layer 20 including the first layer 21 and the second layer 22, the solid electrolyte layer 30, the cathode active material layer 40, and the cathode current collector 50.

The solution may be prepared by adding the electrically conductive material and the binder into a solvent. The electrically conductive material and the binder have been described above. The solvent may include at least one selected from the group consisting of N-methyl-2-pyrrolidone, water, ethanol, isopropanol, and combinations thereof.

The first layer 21 may be formed by applying the solution to the substrate and drying the solution. The substrate may include the anode current collector 10 or a release film. The first layer 21 may be formed by directly applying the solution to the anode current collector 10, or the first layer 21 may be formed by applying the solution to the release film and then the first layer 21 may be transferred to the anode current collector 10.

Application of the solution is not limited to a specific method and may be executed using a method, such as spin coating, drop casting, or the like.

After application of the solution, the first layer 21 may be formed by drying the solution at a temperature of equal to or less than about 100° C.

The second layer 22 may be formed by depositing the metal on the first layer 21 using a method such as chemical vapor deposition (CVD) or physical vapor deposition (PVD). For example, the second layer 22 may be formed through sputtering.

Formation of the stack is not limited to a specific method. The respective elements of the stack may be formed at the same time or at different times. For example, the method may include not only forming the buffer layer 20 directly on the anode current collector 10, forming the solid electrolyte layer 30 directly on the buffer layer 20, forming the cathode active material layer 40 directly on the solid electrolyte layer 30, and forming the cathode current collector 50 directly on the cathode active material layer 40, but also manufacturing the respective elements separately and then stacking the respective elements into the structure shown in FIG. 1.

Hereinafter, embodiments of the present disclosure will be described in more detail through the following examples. The following examples serve merely to exemplarily describe embodiments of the present disclosure, and are not intended to limit the scope of the invention.

### Preparation Example

A solution was prepared by adding a MXene (Ti₃C₂Tₐ), reduced graphene oxide and a binder into a solvent. The binder was a mixture of styrene butadiene rubber (SBR) and carboxymethyl cellulose (CMC), and the solvent was N-methyl-2-pyrrolidone (NMP).

A first layer was formed by applying the solution to an anode current collector and then drying the solution.

A second layer was formed by performing magnesium (Mg) sputtering on the first layer.

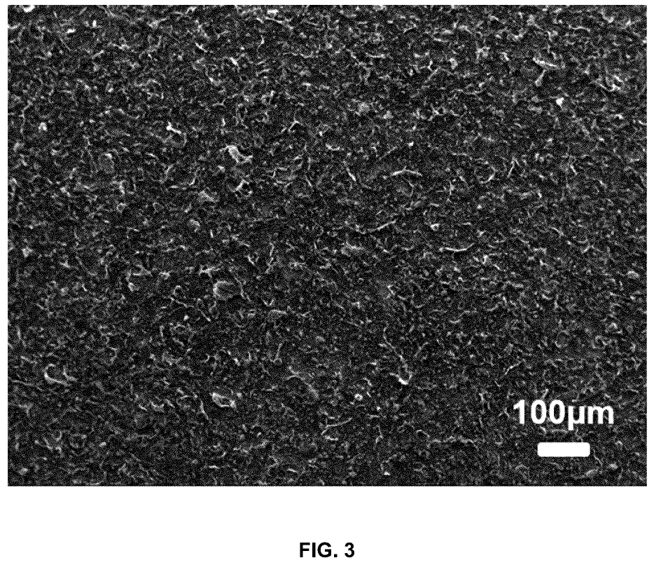

FIG. 3 shows the surface of a buffer layer including the first layer and the second layer, acquired by scanning electron microscopy (SEM) analysis. Concretely, this figure shows the second layer.

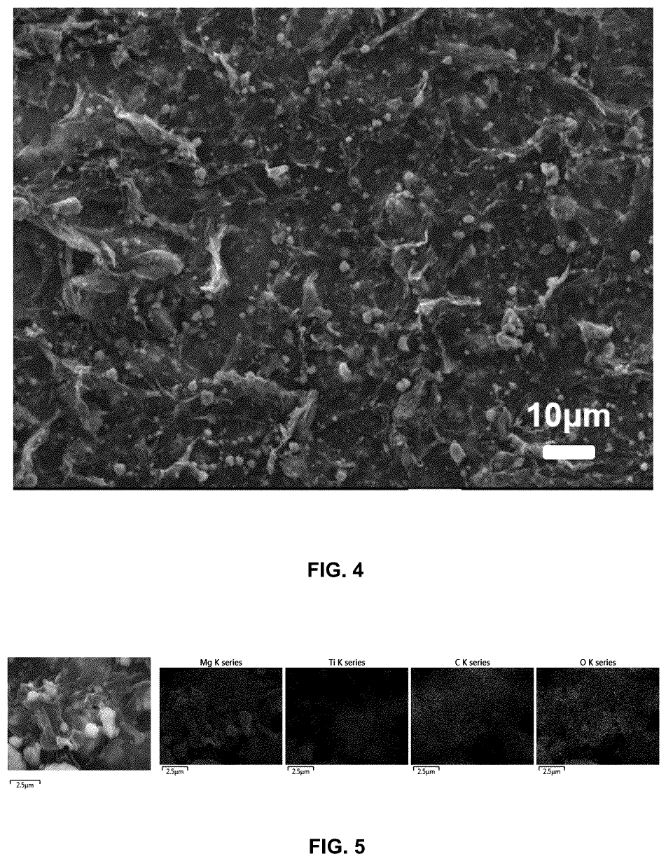

FIG. 4 shows the surface of the buffer layer, acquired by SEM analysis at a different scale from FIG. 3.

FIG. 5 shows the surface of the buffer layer according to a Preparation Example, acquired by energy dispersive X-ray spectroscopy (EDS) analysis. Concretely, this figure shows the second layer. It may be confirmed from results of Ti, C, and O that the first layer was present and magnesium (Mg) was uniformly distributed on the first layer.

### Comparative Preparation Example

A second layer was formed by performing magnesium (Mg) sputtering on an anode current collector without a first layer, in contrast to the Preparation Example.

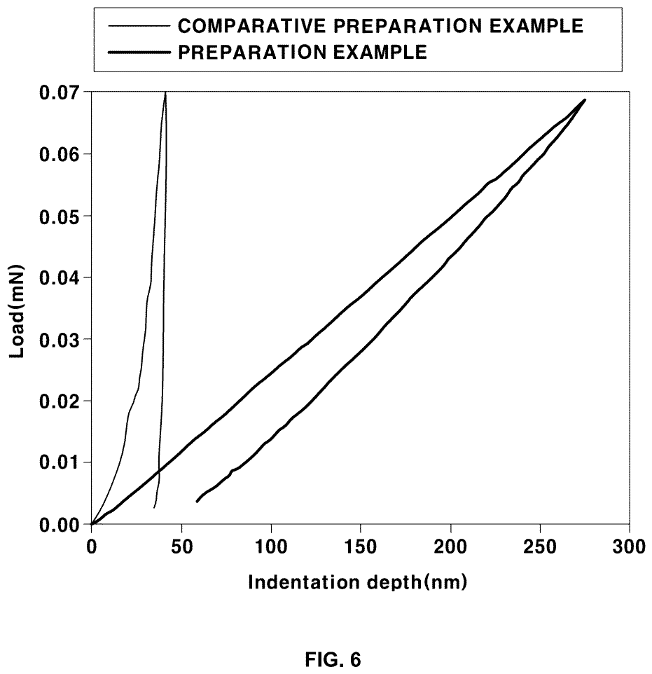

FIG. 6 shows an indentation load for the buffer layer according to the Preparation Example and the buffer layer according to the Comparative Preparation Example. The indentation depths of the respective buffer layers were measured by indenting the tip of a nanoindenter into the surfaces of the respective buffer layers at an indentation load, and the restoration depths of the respective buffer layers were measured when the indentation load is removed. The maximum indentation load was set to 0.07 mN, a time taken to apply the indentation load was set to 15 seconds, and a time taken to remove the indentation load was set to 15 seconds. The indentation depths and restoration ratios of the respective buffer layers are set forth in Table 1 below.

TABLE 1

| Category | Indentation depth | Restoration ratio¹ |
|---|---|---|
| Comparative Preparation | 41.03 nm | 15.7% |
| Example | | |
| Preparation Example | 271.32 nm | 88.2% |

${}^{1} Restoration Ratio [ \% ] = \frac{Restoration Depth}{Indentation Depth} \times 100$

Referring to FIG. 6 and Table 1, the buffer layer according to the Preparation Example exhibited ductility three or more times the ductility of the buffer layer according to the Comparative Preparation Example. Further, the buffer layer according to the Preparation Example exhibited a much higher restoration ratio than the buffer layer according to the Comparative Preparation Example. The buffer layer according to embodiments of the present disclosure has high ductility and may thus maintain uniform interfaces with a solid electrolyte layer and an anode current collector even when an all-solid-state battery including the buffer layer is operated at room temperature and low pressure. Further, the buffer layer according to embodiments of the present disclosure has a high restoration ratio and may thus minimize volume change occurring at the time of charging the all-solid-state battery.

### Example 1

A solid electrolyte layer including a sulfide-based solid electrolyte was stacked on the buffer layer according to the Preparation Example. Li₆PS₅Cl was used as the sulfide-based solid electrolyte. A half-cell was manufactured by attaching lithium metal to the solid electrolyte layer.

### Comparative Example 1

A half-cell was manufactured in the same manner as in Example 1, except that the buffer layer according to the Comparative Preparation Example was used.

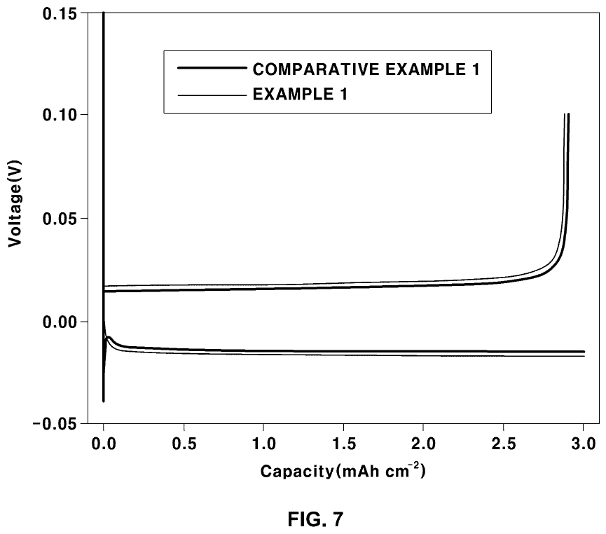

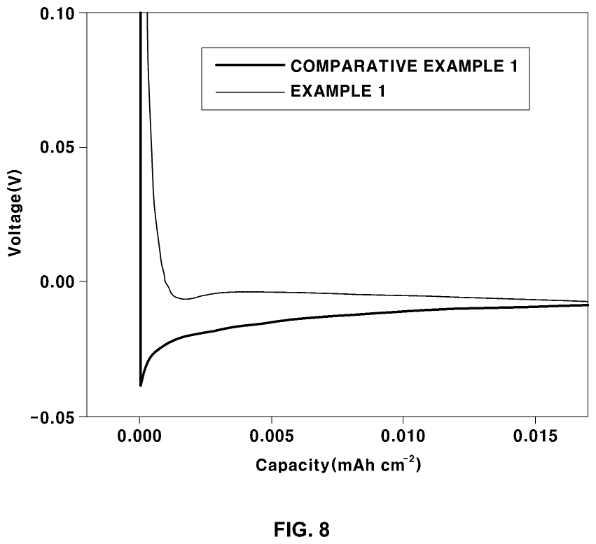

The half-cells according to Example 1 and Comparative Example 1 were charged and discharged at a current density of 1 mA/cm², a deposition capacity of 3 mAh/cm², and a temperature of 25° C. FIG. 7 shows initial charge and discharge voltages of the half-cells according to Example 1 and Comparative Example 1. FIG. 8 shows an enlarged graph of one capacity section of FIG. 7. Referring to these figures, it may be confirmed that, in the case of the half-cell according to Example 1, overvoltage was greatly reduced compared to the half-cell according to Comparative Example 1. Concretely, when the all-solid-state battery according to embodiments of the present disclosure is charged at a current density of 1 mA·cm⁻² under conditions of a temperature of 15° C. to 25° C. and a pressure of 1 MPa to 10 MPa, overvoltage may not occur or overvoltage equal to or less than 50 mV may occur. The above result is caused by reduction in overvoltage depending on lithium nucleation and growth of the half-cell according to Example 1. This means that the half-cell according to Example 1 may stably maintain interfaces between the respective layers in response to volume change occurring at the time of charging and discharging, compared to the half-cell according to Comparative Example 1.

### Example 2

A solid electrolyte layer including a sulfide-based solid electrolyte was stacked on the buffer layer according to the Preparation Example. Li₆PS₅Cl was used as the sulfide-based solid electrolyte.

A cathode active material layer including a cathode active material was stacked on the solid electrolyte layer. NCM711 (LiNi_{0.7}Co_{0.15}Mn_{0.15}O₂) was used as the cathode active material. The loading amount of the cathode active material was adjusted to about 13 mg/cm².

A full cell was manufactured by attaching a cathode current collector to the cathode active material layer.

### Comparative Example 2

A full cell was manufactured in the same manner as in Example 2, except that the buffer layer according to the Comparative Preparation Example was used.

### Comparative Example 3

After lithium metal was attached to an anode current collector, a solid electrolyte layer including a sulfide-based solid electrolyte was stacked on the lithium metal. Li₅PS₆Cl was used as the sulfide-based solid electrolyte.

A cathode active material layer including a cathode active material was stacked on the solid electrolyte layer. NCM711 (LiNi_{0.7}Co_{0.15}Mn_{0.15}O₂) was used as the cathode active material. The loading amount of the cathode active material was adjusted to about 13 mg/cm².

A full cell was manufactured by attaching a cathode current collector to the cathode active material layer.

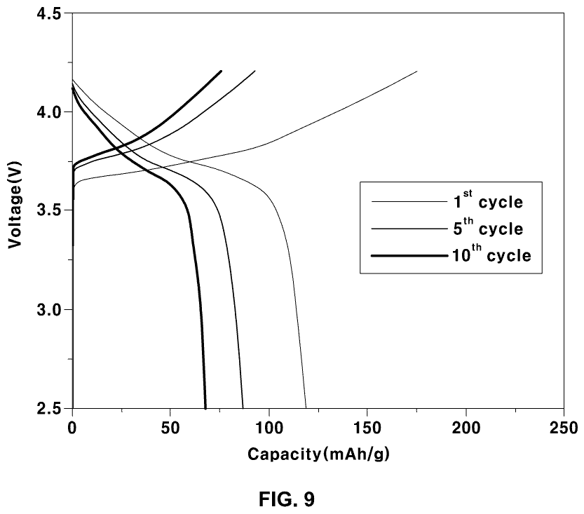

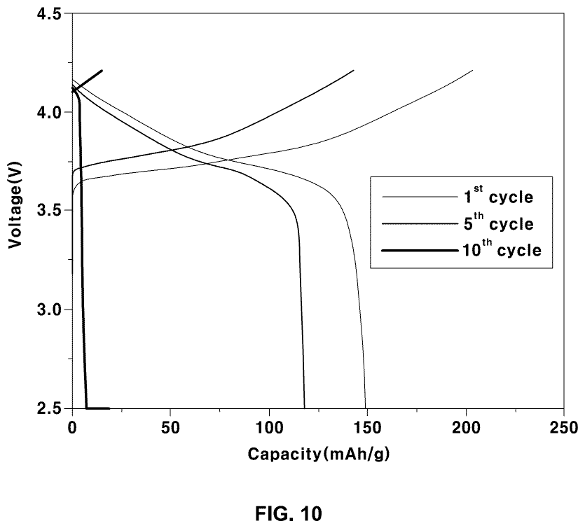

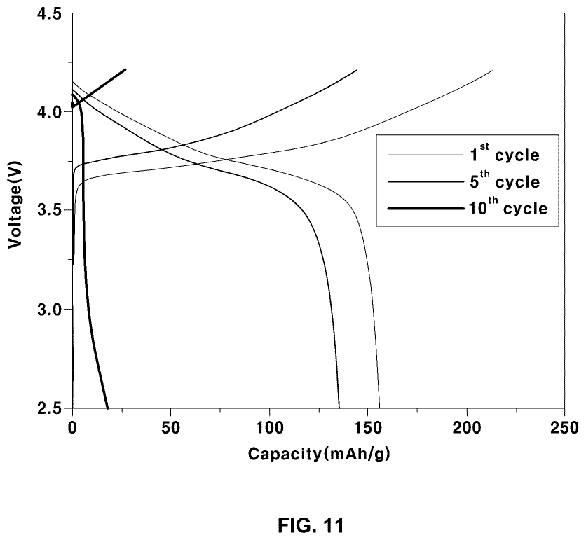

The full cells according to Example 2, Comparative Example 2, and Comparative Example 3 were charged and discharged under conditions of 2.5 V-4.2 V, 0.1 C, 25° C. and 4 MPa. FIG. 9 shows results of charging and discharging the full cell according to Example 2 at room temperature and low pressure. FIG. 10 shows results of charging and discharging the full cell according to Comparative Example 2 at room temperature and low pressure. FIG. 11 shows results of charging and discharging the full cell according to Comparative Example 3 at room temperature and low pressure.

It may be confirmed that the full cell according to Example 2 maintained about 50% of the capacity thereof in the tenth cycle even when the full cell was operated at room temperature and low pressure. That is, it may be confirmed that the all-solid-state battery including the buffer layer according to embodiments of the present disclosure may minimize volume change depending on charging and discharging of the all-solid-state battery and may stably maintain the interfaces between the respective layers due to the high ductility of the buffer layer even in room-temperature and low-pressure conditions.

As is apparent from the above description, embodiments of the present disclosure may provide an all-solid-state battery which may be operated at room temperature and low pressure.

Embodiments of the invention have been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An all-solid-state battery comprising:
an anode current collector;
a buffer layer disposed on the anode current collector;
a solid electrolyte layer disposed on the buffer layer and comprising a solid electrolyte;
a cathode active material layer disposed on the solid electrolyte layer; and
a cathode current collector disposed on the cathode active material layer,
wherein the buffer layer comprises:
a first layer disposed on the anode current collector and comprising an electrically conductive material; and
a second layer disposed on the first layer and comprising a metal capable of alloying with lithium.

2. The all-solid-state battery of claim 1, wherein electrical conductivity of the first layer is 0.1 S/m to 10 S/m.

3. The all-solid-state battery of claim 1, wherein the electrically conductive material comprises a MXene and a carbon material.

4. The all-solid-state battery of claim 3, wherein the carbon material comprises at least one of graphene, graphene oxide, reduced graphene oxide or any combination thereof.

5. The all-solid-state battery of claim 3, wherein the first layer comprises the MXene and the carbon material in a mass ratio of 10:90 to 90:10.

6. The all-solid-state battery of claim 1, wherein the first layer further comprises a binder,
wherein the binder comprises at least one of styrene butadiene rubber, carboxymethyl cellulose, polyvinylidene fluoride or any combination thereof.

7. The all-solid-state battery of claim 1, wherein the metal comprises at least one of magnesium (Mg), silver (Ag), zinc (Zn), gold (Au) or any combination thereof.

8. The all-solid-state battery of claim 1, wherein a thickness of the second layer is 100 nm to 1,000 nm.

9. The all-solid-state battery of claim 1, wherein a thickness of the buffer layer is 1 μm to 50 μm.

10. The all-solid-state battery of claim 1, wherein an indentation depth of the buffer layer is 100 nm to 300 nm based on an indentation load of 0.07 mN.

11. The all-solid-state battery of claim 1, wherein a restoration ratio of the buffer layer calculated by an equation,
$$Restoration Ratio [ \% ] = \frac{Restoration Depth}{Indentation Depth} \times 100 ,$$
is 50% to 99%.

12. The all-solid-state battery of claim 1, wherein, when the all-solid-state battery is charged at a current density of 1 mA·cm⁻² under conditions of a temperature of 15° C. to 25° C. and a pressure of 1 MPa to 10 MPa, overvoltage does not occur or overvoltage equal to or less than 50 mV occurs.

13. A method of manufacturing an all-solid-state battery, the method comprising:
forming a first layer by applying a solution comprising an electrically conductive material to a substrate;
forming a second layer by depositing a metal capable of alloying with lithium on the first layer; and
manufacturing a stack comprising an anode current collector, a buffer layer disposed on the anode current collector and comprising the first layer and the second layer, a solid electrolyte layer disposed on the buffer layer and comprising a solid electrolyte, a cathode active material layer disposed on the solid electrolyte layer, and a cathode current collector disposed on the cathode active material layer.

14. The method of claim 13, wherein:
the solution comprises the electrically conductive material, a binder, and a solvent;
the electrically conductive material comprises a MXene and a carbon material;
the carbon material comprises at least one of graphene, graphene oxide, reduced graphene oxide or any combination thereof;
the binder comprises at least one of styrene butadiene rubber, carboxymethyl cellulose, polyvinylidene fluoride or any combination thereof; and
the solvent comprises at least one of N-methyl-2-pyrrolidone, water, ethanol, isopropanol or any combination thereof.

15. The method of claim 14, wherein the first layer comprises the MXene and the carbon material in a mass ratio of 10:90 to 90:10.

16. The method of claim 13, wherein the metal comprises at least one of magnesium (Mg), silver (Ag), zinc (Zn), gold (Au) or any combination thereof.

17. The method of claim 13, wherein:
a thickness of the second layer is 100 nm to 1,000 nm; and
a thickness of the buffer layer is 1 μm to 50 μm.

18. The method of claim 13, wherein an indentation depth of the buffer layer is 100 nm to 300 nm based on an indentation load of 0.07 mN.

19. The method of claim 13, wherein a restoration ratio of the buffer layer calculated by an equation,
$$Restoration Ratio [ \% ] = \frac{Restoration Depth}{Indentation Depth} \times 100 ,$$
is 50% to 99%.

20. The method of claim 13, wherein, when the all-solid-state battery is charged at a current density of 1 mA·cm⁻² under conditions of a temperature of 15° C. to 25° C. and a pressure of 1 MPa to 10 MPa, overvoltage does not occur or overvoltage equal to or less than 50 mV occurs.
